(19) United States
(12) Patent Application Publication
(10) Pub. No.: US 2025/0347146 A1
(43) Pub. Date: Nov. 13, 2025

(54) CUSTOMIZABLE CABINET AND DRAWER KNOB

(71) Applicant: Arijit Kakkar, O'Fallon, MO (US)

(72) Inventor: Arijit Kakkar, O'Fallon, MO (US)

(21) Appl. No.: 19/203,753

(22) Filed: May 9, 2025

Related U.S. Application Data
(60) Provisional application No. 63/645,285, filed on May 10, 2024.

(51) Int. Cl. E05B 1/00; A47G 1/06

(52) U.S. Cl. CPC E05B 1/0084; A47G 1/06; E05B 1/0015

(57) ABSTRACT

A knob for showcasing one of a plurality of interchangeable display components is disclosed. The knob provides a base having a first surface and a second surface separated by a peripheral base attachment surface. The knob has a collar with a hollow body extending from a proximal edge, defining a proximal opening, to a distal edge, defining a distal opening. The collar has a collar attachment surface that is removably attachable to the peripheral base attachment surface to move between a disengaged condition to an engaged condition with the first surface adjacent to the distal edge of the hollow body. A stop flange projecting radially inward from the distal edge to define a window within the distal opening. One of the plurality interchangeable display components dimensioned to slide through the proximal opening and be sandwiched between the first surface and the stop flange in the engaged condition.

### CROSS REFERENCE TO RELATED APPLICATION

This application claims the benefit of priority of U.S. provisional application No. 63/645,285, filed May 10, 2024, the contents of which are herein incorporated by reference.

### BACKGROUND OF THE SUBJECT DISCLOSURE

The subject disclosure relates to cabinetry and, more particularly, to a customizable cabinet and drawer knob.

A cabinet knob or drawer knob can be made from several materials but once it is made it does not have the ability to look different from its original ornamental appearance. For instance, a blue glass knob will always be a blue glass knob and a ceramic knob, no matter its color or design, does not have the ability to look like anything else but its original ceramic design. Similarly, a metal knob, no matter whether it's brass, iron or aluminum or any other material, does not have the ability to easily change to a non-metallic look without permanently altering or marring the knob until the next not-so easy change.

Knobs have existed forever, however none of the knobs currently available in the market can change the way they look from the front without physically changing them, like painting over the current front surface.

As can be seen, there is a need for a customizable cabinet and drawer knob, thereby giving the user the ability to change, within minutes, the front-facing look of the knob with innumerable, interchangeable options, thereby affording the user the ability to customize the knob's design.

### SUMMARY OF THE SUBJECT DISCLOSURE

The knob embodied in the subject disclosure gives the user the ability to exchange a display component an unlimited number of times, wherein the new display component could be one of a multitude of materials and embody countless designs. The user is also not bound to buy the display component from a purveyor, as the user can make their own display component, further increasing the myriads of interchangeable ornamental displays.

In one aspect of the present subject disclosure, knob for showcasing one of a plurality of interchangeable display components, the knob provides the following: a base having a first surface and a second surface separated by a peripheral base attachment surface; a collar having a hollow body extending from a proximal edge, defining a proximal opening, to a distal edge, defining a distal opening; the collar having a collar attachment surface along an inner surface of the hollow body, wherein the collar attachment surface and the peripheral base attachment surface are configured to removably attach from a disengaged condition to an engaged condition with the first surface adjacent to the distal edge of the hollow body; a stop flange projecting radially inward from the distal edge to define a window within the distal opening; an interchangeable display component dimensioned to slide through the proximal opening and be sandwiched between the first surface and the stop flange in the engaged condition; and wherein an ornamental design is visible through the window, and wherein by the interchangeable display component is separable from the base and the collar, whereby the interchangeable ornamental design is interchangeable with another of the plurality of interchangeable display components.

In another aspect of the present subject disclosure, the dynamic knob further includes the following: wherein the hollow body is a tube and wherein the base is flat and having, in some embodiments, a circular periphery, wherein the peripheral base attachment surface and the collar attachment surface are complementary threaded surfaces; further providing a post joined to and perpendicularly extending away from a center point of the second surface; further providing a post flange along a distal end of the post, wherein the post flange provides a fastener point for rotatably engaging the post to facilitate moving between the disengaged condition and the engaged condition, wherein the ornamental design is attached to the first surface, or wherein the ornamental design is detached from the first surface, and wherein a transparent layer is sandwiched between the ornamental design and the stop flange.

These and other features, aspects and advantages of the present subject disclosure will become better understood with reference to the following drawings, description and claims.

### BRIEF DESCRIPTION OF THE DRAWINGS

FIG. 1 is an exploded perspective view of an exemplary embodiment of the subject disclosure.

FIG. 2 is a front perspective view of an exemplary embodiment of the subject disclosure.

FIG. 3 is a rear perspective view of an exemplary embodiment of the subject disclosure.

FIG. 4 is a rear elevation view of an exemplary embodiment of the subject disclosure.

FIG. 5 is a front elevation view of an exemplary embodiment of the subject disclosure.

FIG. 6 is a front elevation view of an exemplary embodiment of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

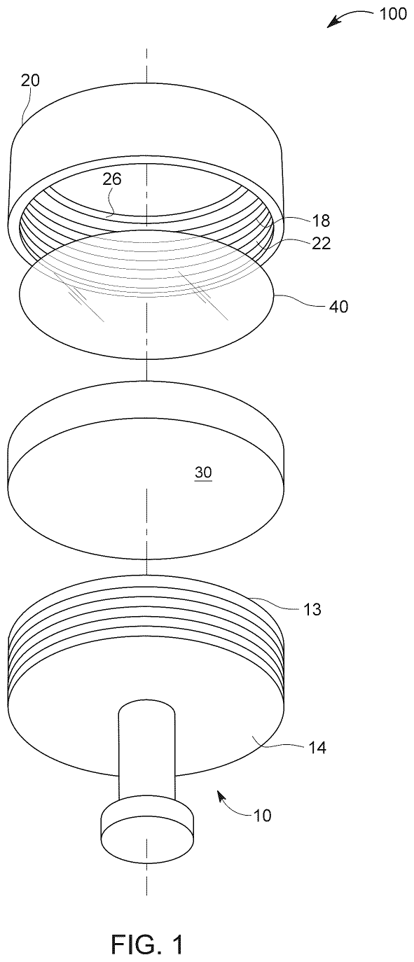

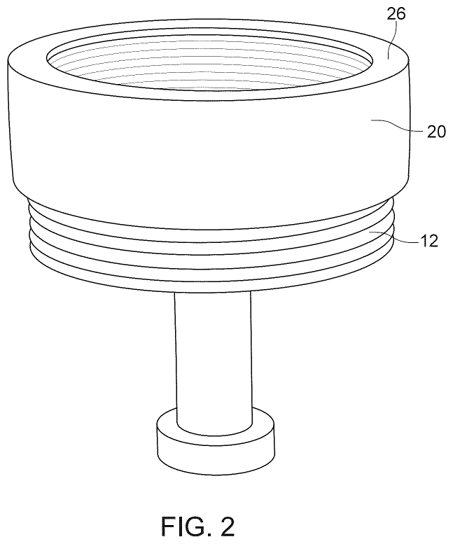

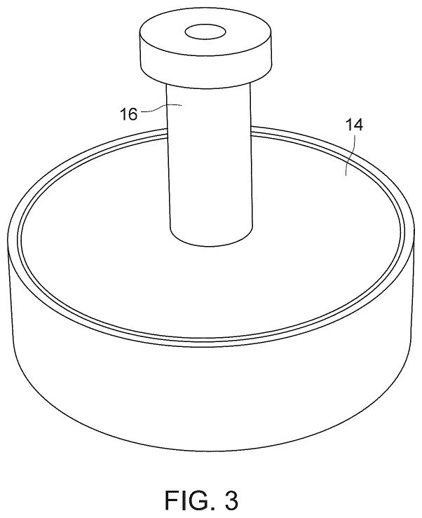

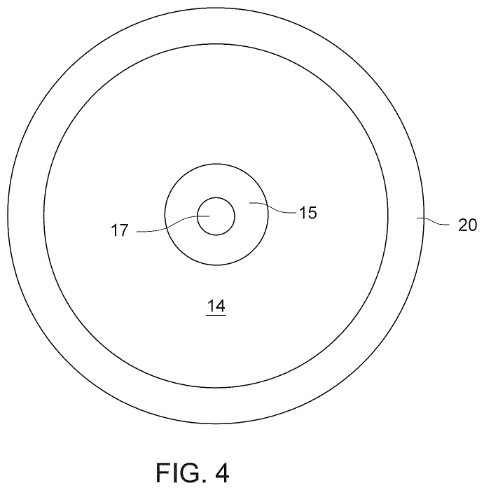

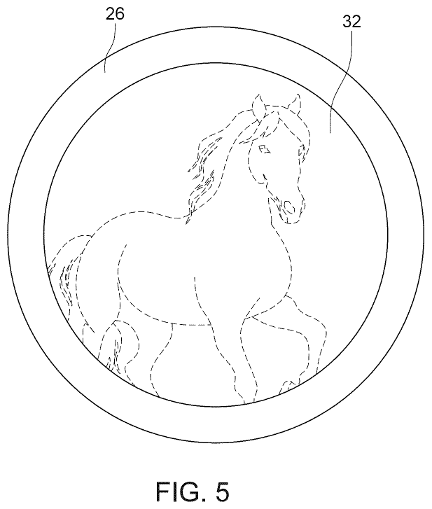

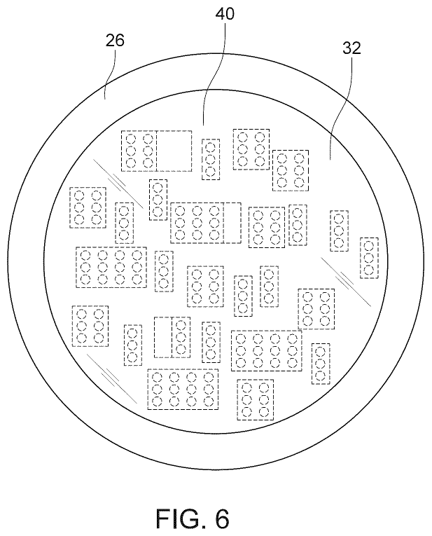

Referring now to FIGS. 1 through 6, the subject disclosure may include a dynamic knob 100. The dynamic knob 100 enables the user the ability to give it a different look by way of an interchangeable display component, where one change does not restrict the user from making futures changes to the dynamic knob 100, if they choose.

The dynamic knob 100 includes an arcuate base 10 having a first surface 13 and a second surface 14 opposite the first surface 13. Along the circumferential sidewalls of the arcuate base 10, between the first and second surfaces 13 and 14, is a threaded surface 12.

A post 16 may be orthogonally joined to the second surface 14. Typically, the post is cylindrical and centrally located along the second surface 14. At a distal end of post 16, opposite the end of post 16 that is joined to the second surface 14 may be a concentric flange 15. The flange 15 has a diameter ten or more percent greater than the diameter of the cylindrical post 16. The post flange 15 may have a fastener point 17 for facilitating the rotating of the post 16 and thus the base 10 when threading and unthreading the base 10 relative to the collar 20.

An arcuate collar 20 provides an inner threaded surface 22 that operatively associates and disassociates with the distal portion 14 of the base 10 so that the arcuate collar 20 is removably attachable thereto. The arcuate collar is generally tubular with two open ends.

A display component 30 may be dimensioned and shaped to be housed within the inner circumference of the arcuate collar 20, yet the dimensions and shape of the display component 30 prevent it from sliding past a stop flange 26 that provided along a distal edge of the arcuate collar 20. The stop flange 26 extends radially inward from the distal edge of the arcuate collar 20, thereby reducing the opening of the arcuate collar 20 at its distal edge. The underside of the stop flange 26 defines a stop surface 18 facing the hollow of the arcuate collar 20.

Accordingly, a user may remove the arcuate collar 20 from the arcuate base 10 by unthreading the respective threaded surfaces 12 and 26, then place the display component 30 against the first surface 13 of the base 10, or have it urged against the stop surface 18 and then engage and tighten the arcuate collar 20 by way of the complementary threading 12, 22 until the first surface 13 sandwiches the periphery of the display component 30 against the stop surface 18, thereby securing the display component 30.

Since the arcuate collar 20 can be removed attached to the base 10, and a user may have many different display components 30, each with their own ornamental design 32 or message, then the user may selectively change the ornamental appearance of the underlying dynamic knob 100 based on their current preference.

For instance, if the dynamic knob 100 is being used in an infant's room and has a baby theme (image/symbol/signal), as the child grows the user can change the ornamental design 32, and thus the look and feel, of the dynamic knob 100 in accordance with the changing preferences of the child. In contrast, with a traditional knob the user would either be stuck with what they have or buy new ones.

Furthermore, the dynamic knob 100 has been designed to work with a vast number of ornamental designs 32 as the display component can selectively carry or support different design elements. For instance, a user could cut out pictures of their children and insert that picture between the arcuate collar 20 and the stop surface 18, or one could use any other preferred image. Also possible, users could fill the space between a transparent layer 40 urged against the stop flange 26 and the first surface 13 with small beads or any other material. The display component 30 can be a round piece of wood, round carved stone or any other material that can fit within the cavity between the first surface 13 and the stop surface 18. The ornamental design options are practically countless.

It should also be appreciated that the operative association between the base 10 and the collar 20 can take many forms as long as such operative associations detachably secure the display component 30 between the base 10 and the stop surface 18, so that an ornamental design 32 along the surface of display component 30 is visible through the front-facing opening of the collar 20. In other words, the subject disclosure is not limited to the threaded mating of the base 10 to the arcuate collar 20 but other removably attachment methods could be used that enable the interchangeability functionality of the display component 30 removably secured between the base 10 and the stop surface 18 to be viewable through the arcuate collar 20. Examples include, but are not limited to re-attachable adhesive, magnets, hook and loop fasteners, and the like.

As a result, the shape of the collar and base need not be arcuate and still be contemplated by the subject disclosure. For instance, both the base 10 and the collar 20 may be rectangular or any other geometrical shape as long as they can sandwich a display component 30 against the stop surface 18.

The dynamic knob 100 embodied in the subject disclosure comprises of three parts with the display component 30 being the dynamic part, thereby enabling a user to change the filler as they fancy with limitless options and times. This is the new function which is not available today.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A knob for showcasing one of a plurality of interchangeable display components, the knob comprising:
a base having a first surface and a second surface separated by a peripheral base attachment surface;
a collar having a hollow body extending from a proximal edge, defining a proximal opening, to a distal edge, defining a distal opening;
the collar having a collar attachment surface along an inner surface of the hollow body,
wherein the collar attachment surface and the peripheral base attachment surface are configured to removably attach from a disengaged condition to an engaged condition with the first surface adjacent to the distal edge of the hollow body;
a stop flange projecting radially inward from the distal edge to define a window within the distal opening;
an interchangeable display component dimensioned to slide through the proximal opening and be sandwiched between the first surface and the stop flange in the engaged condition; and
wherein an ornamental design is visible through the window, and wherein by the interchangeable display component is separable from the base and the collar, whereby the interchangeable ornamental design is interchangeable with another of the plurality of interchangeable display components.

2. The knob of claim 1, wherein the hollow body is a tube and wherein the base is peripherally circular.

3. The knob of claim 2, wherein the peripheral base attachment surface and the collar attachment surface are complementary threaded surfaces.

4. The knob of claim 3, further comprising a post joined to and perpendicularly extending away from a center point of the second surface.

5. The knob of claim 4, further comprising a post flange along a distal end of the post.

6. The knob of claim 5, wherein the post flange provides a fastener point for rotatably engaging the post to facilitate moving between the disengaged condition and the engaged condition.

7. The knob of claim 6, wherein the ornamental design is attached to the first surface.

8. The knob of claim 6, wherein the ornamental design is detached from the first surface, and wherein a transparent layer is sandwiched between the ornamental design and the stop flange.
